(19) United States
(12) Patent Application Publication
(10) Pub. No.: US 2017/0298733 A1
(43) Pub. Date: Oct. 19, 2017

(54) COMPOSITE MOLDED ROTARY COMPONENT

(71) Applicant: Eaton Corporation, Cleveland, OH (US)

(72) Inventors: Kelly Ann WILLIAMS, South Lyon, MI (US); Willaim Nicholas EYBERGEN, Harrison Township, MI (US); Javed Abdurrazzaq MAPKAR, Commerce Township, MI (US); Bradley Karl WRIGHT, Jr., Dayton, OH (US)

(73) Assignee: Eaton Corporation, Cleveland, OH (US)

(21) Appl. No.: 15/514,409

(22) PCT Filed: Sep. 25, 2015
(86) PCT No.: PCT/US2015/052332

§ 371 Date: Mar. 24, 2017

Related U.S. Application Data
(60) Provisional application No. 62/055,373, filed on Sep. 25, 2014.

(51) Int. Cl. F01C 1/12; B29C 45/14; F04C 18/12; B29L 15/00; B29K 105/20; B29K 63/00; F02B 33/38

(52) U.S. Cl. CPC F01C 1/126; B29C 45/14631; B29C 45/14008; F04C 18/126; B29K 2105/20; B29K 2063/00; F02B 33/38; F04C 2240/20; F04C 2240/60; B29L 2015/003

(57) ABSTRACT

The present teachings generally include a composite rotor assembly comprising a shaft and a rotor body mounted to the shaft. The rotor body can include a core structure including a cured polymeric material wholly or partly defining plurality of lobes joined by adjacent root portions. The rotor body can also include a support structure continuously extending the length of the core structure to provide additional structural integrity to the rotor body. The support structure can be wholly or partially embedded within the core structure and can also be wrapped around the exterior of the core structure. In one example, the core structure includes an epoxy resin and the support structure includes a carbon fiber material.

### CROSS-REFERENCE TO RELATED APPLICATION

This application is being filed on Sep. 25, 2015 as a PCT International Patent Application and claims the benefit of U.S. Patent Application Ser. No. 62/055,373, filed on Sep. 25, 2014, the disclosure of which is incorporated herein by reference in its entirety.

### TECHNICAL FIELD

This present disclosure relates to rotary components and assemblies constructed from rotary components that may be utilized in rotary equipment applications, for example, volumetric expansion, compression devices, gear trains, pumps, and mixing devices.

### BACKGROUND

Rotors are a commonly used in applications where it is desirable to compress or move a fluid and where it is desired to remove energy from the fluid. In one example, a compressor or supercharger utilizes a pair of rotors to increase airflow into the intake of an internal combustion engine. In another example, a volumetric fluid expander includes a pair of rotors that expand a working fluid to generate useful work at an output shaft. Rotary components are also utilized in other applications, such as in gear trains, pumps, and mixing devices. In many such applications, it is known to provide machined or cast rotary components having a unitary construction with a solid cross-sectional area.

A typical roots-style device has two rotors that rotate about respective axes. The rotors include lobes that intermesh with one another. Rotation of the rotors is timed such that the rotors do not contact one another. A typical rotor is manufactured from extruded aluminum that is finished to a desired shape. Abradable coatings can be used on the rotors to provide tight tolerances between the rotors and their corresponding rotor housings.

The use of aluminum to manufacture roots-style rotors presents a number of problems. For example, aluminum is relatively heavy which results in reduced response time and parasitic loss on the engine. Additionally, the weight associated with aluminum rotors can present problems for clutch durability. Moreover, extruding and then finishing aluminum can be a fairly expensive process. The benefits associated with aluminum include the ability to make extremely precise parts. Additionally, the aluminum construction provides much strength at the roots of the roots-style rotors.

### SUMMARY

The present teachings generally include a composite rotor assembly comprising a shaft and a rotor body mounted to the shaft. The rotor body can include a core structure including a cured polymeric material, wherein the core structure can define a first length, a central opening through which the shaft extends and a plurality of lobes extending away from the central opening. In one aspect, each of the lobes can be joined by an adjacent root portion and having a longitudinal axis intersecting the center of the central opening. The rotor body can also include a support structure continuously extending the length of the core structure. The support structure can be wholly or partially embedded within the core structure and can also be wrapped around the exterior of the core structure. In one aspect, the support structure can include a plurality of fibers.

The present teachings also include processes for making a composite rotor assembly. One step can include providing a support structure and one or more materials for a core structure. Another step can be inserting the support structure into a mold while another step can be inserting a shaft into the mold. Other steps can include introducing the one or more materials for the core structure into the mold and then allowing curable portions of the one or more materials of the core structure to cure. The composite rotor can then be removed from the mold. The shaft may be provided with various surface features better engage the shaft with the composite rotor body. The process may also include applying an abradable coating to the rotor and balancing the rotor.

Many materials may be used in accordance with the present teachings. For example thermoplastic materials can be provided. The thermoplastic material can be provided in thread formed integrated with reinforcing fibers. Thermoplastic fibers are typically melted during a heating process. Thermoset materials can also be utilized. In the case of thermoset materials, the thermoset materials would typically be injected into the fiber reinforcing fibers to wet them. In this way, the fibers form a textile type layer of reinforcing material. In other examples, chopped fibers can be laid or otherwise applied to provide reinforcement to the rotors. A number of different configurations are also possible, provided they are suitable for providing adequate roots strength and thermal stability. Preferably, each of the variations are manufactured using a net-shaped molding process so that no further finishing is required after molding.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a front view of a first example of a composite rotor body in accordance with the principles of the present teachings.

FIG. 2 is a front view of a second example of a composite rotor body in accordance with the principles of the present teachings.

FIG. 3 is a front view of a third example of a composite rotor body in accordance with the principles of the present teachings.

FIG. 4 is a front view of a fourth example of a composite rotor body in accordance with the principles of the present teachings.

FIG. 5 is a front view of a fifth example of a composite rotor body in accordance with the principles of the present teachings.

FIG. 6 is a front view of a sixth example of a composite rotor body in accordance with the principles of the present teachings.

FIG. 7 is a perspective view of a shaft onto which the rotor bodies of FIGS. 1-6 may be mounted.

FIG. 8 is a perspective view of an assembled rotor utilizing any of the rotor bodies of FIGS. 1-3 and the shaft of FIG. 7.

FIG. 9 is a perspective view of an assembled rotor utilizing any of the rotor bodies of FIGS. 4-6 and the shaft of FIG. 7.

FIG. 10 is a schematic view of a vehicle having a fluid expander and a compressor in which rotor assemblies of the type shown in FIGS. 8 and 9 may be included.

FIG. 11 is a flow diagram describing a first process for making the rotors of FIGS. 8 and 9.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible examples for the appended claims. Referring to the drawings wherein like reference numbers correspond to like or similar components throughout the several figures.

### Rotor Construction

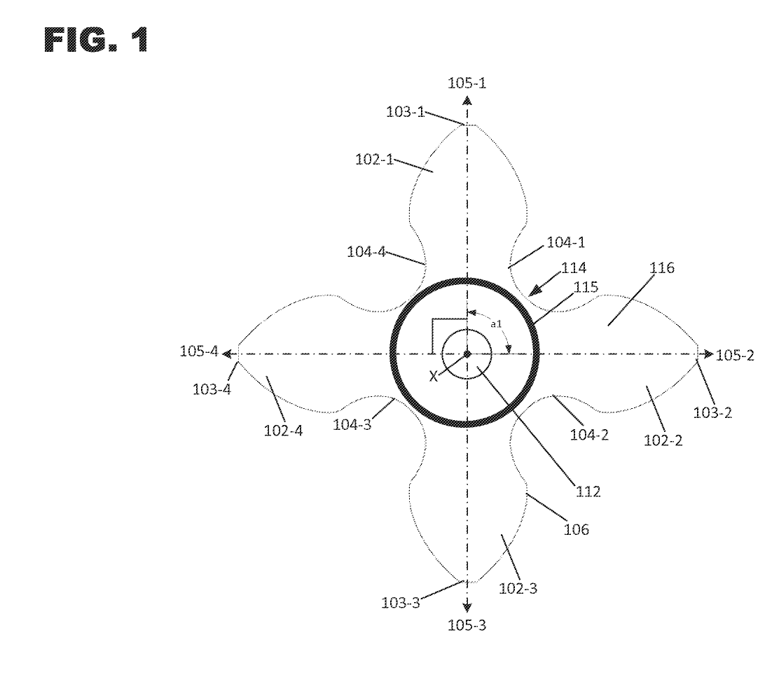

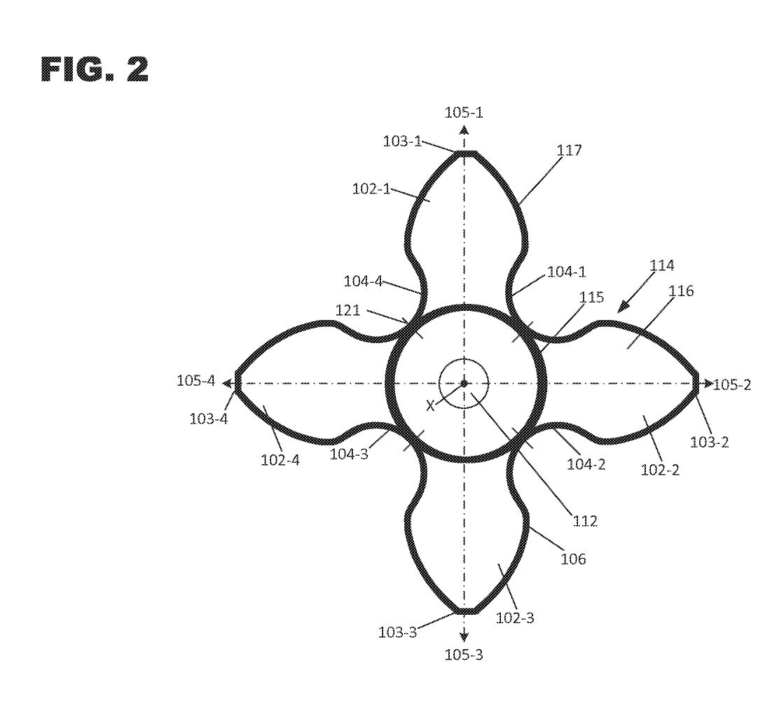

A first example of the present teachings includes a composite rotor body 100 that can be used to form a rotor 30 shown at FIGS. 1-3. As shown, rotor body 100 can have four radially spaced lobes 102-1, 102-2, 102-3, 102-4 (collectively referred to as lobes 102) extending away from a central axis X along a longitudinal axis 105-1, 105-2, 105-3, 105-4 to a respective tip portion 103-1, 103-2, 103-3, 103-4 (collectively tips 103). In the example of FIGS. 1-2, the longitudinal axes 105-1 and 105-3 are coaxial while the longitudinal axes 105-2 and 105-4 are also coaxial.

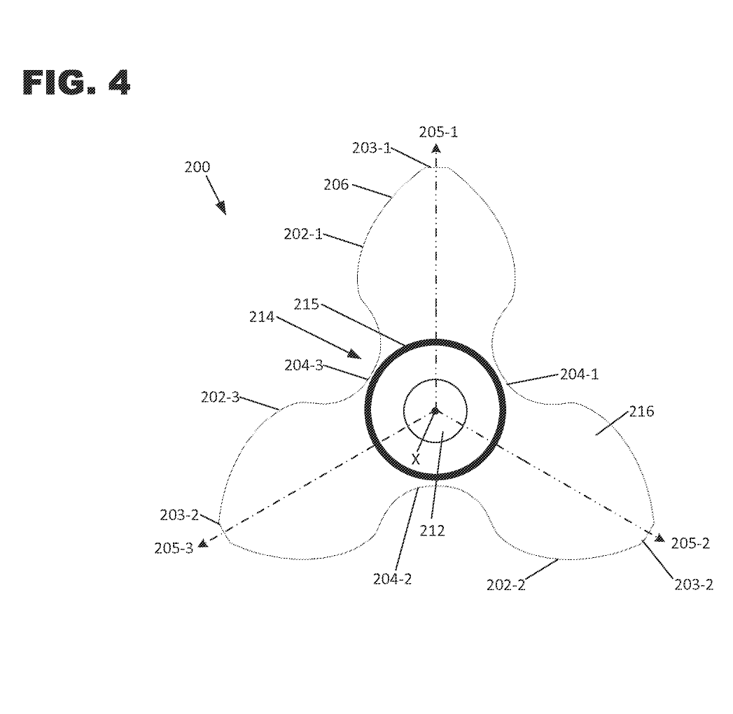

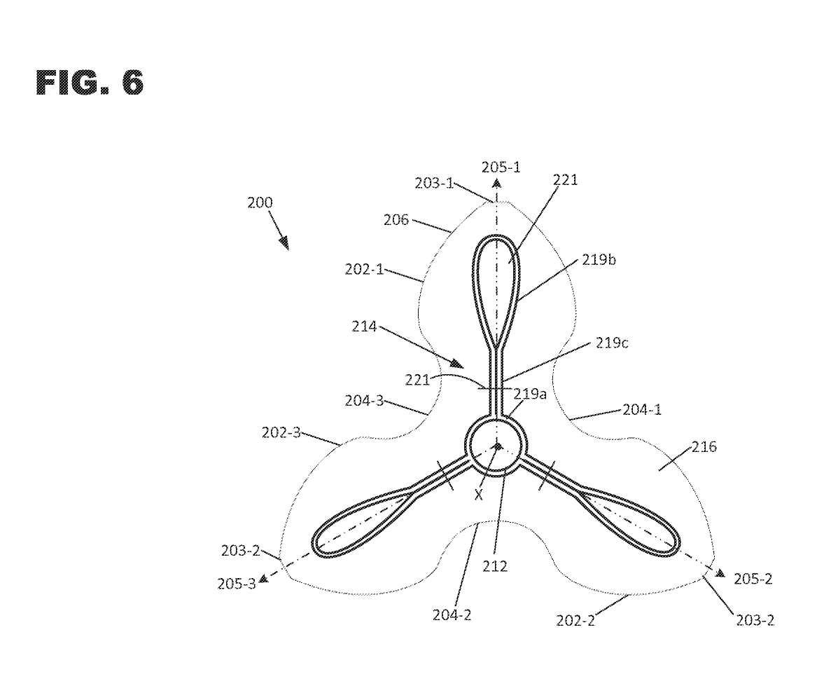

As shown, the lobes 102 are equally spaced apart at a first separation angle a1. In the example shown, the separation angle a1 is about 90 degrees such that axes 105-1/105-3 are orthogonal to axes 105-2/105-4. Although four lobes are shown, it should be understood in light of the disclosure that fewer or more lobes may be provided with corresponding separation angles, for example, two lobes with a separation angle of 180 degrees, three lobes with a separation angle of 120 degrees as shown in FIGS. 4-6 (discussed later), five lobes with a separation angle of 72 degrees, and six lobes with a separation of 60 degrees. When molded to form a rotor 30, the central axis X of the rotor body 100 can be coaxial with axis X1 or the rotor 30.

As shown, the lobes 102 are joined together by adjacent root portions 104-1, 104-2, 104-3, 104-4 (collectively referred to as root portions 104). In the particular example shown, the lobes 102 can have or define a convex outline or perimeter nearest the tips 103 and the root portions 104 have or define a concave outline or perimeter. Taken together, the lobes 102 and the root portions 104 can define an outer perimeter 106 of the rotor body 100. It is noted that lobes 102 are not limited to being defined as convex and can have a shape defined by straight or concave lines. Likewise, the root portions 104 are not limited to being defined as concave and can have a shape defined by straight or convex lines. In one example, the outer perimeter 106 of the rotor bodies 100, 200 at the lobes 102 is defined in the form of an involute shape such that adjacent rotary components 30 can operate as co-acting gears.

In one example, the rotor body 100 can be formed with a central opening 112 for accepting a rotor shaft. Alternatively, the rotor body 100 can be molded onto a shaft such that the central opening 112 is wholly or partly defined by the rotor shaft. As shown, the central opening 112 can be centered on the central axis X.

In one aspect, the rotor body 100 can include a support structure 114 and a core structure 116. The core structure 116 can provide the rotor body 100 with the majority of the volume required for the body 100 without adding undue mass and rotational inertia to the rotor body 100. The support structure 114 can provide the rotor body 100 with additional structural support and stability so as to provide adequate hoop strength and thermal stability to the rotor body 100.

In one example, the support structure 114 can include continuous fibers arranged in a braid, knit, lay stitch, lay weave or other type of configurations. Non-limiting examples of suitable fibers are carbon fibers (low, medium, and high modulus), boron fibers, fiberglass fibers, aramid fibers (e.g. KEVLAR®), and combinations thereof. Other type of materials, such as metal fibers (e.g. steel, aluminum, titanium, etc.), may be used as well. The support structure 114 may also include fibers of different material types or of all the same type.

In one aspect, the support structure 114 may be formed from a plurality of fibers that can be arranged in a variety of respective orientations to provide adequate hoop strength to the rotor. In one example each of the plurality of fibers can extend along a single orientation axis to form a unidirectional substrate (i.e. a “0” substrate). In one example, some of the fibers can be oriented orthogonally to the remaining fibers to form a bidirectional substrate (i.e. a “0/90” substrate). The fibers may also be aligned along three different axes to form a tri-axial weave (i.e. a “0/+45/−45” substrate) and may also be aligned along four different axes to form a quad-axial weave (i.e. a “0/+45/−45/90” weave). Many other orientations are possible without departing from the present teachings.

The plurality of fibers in the support structure 114 may also be are woven or non-woven (e.g. chopped fibers and unidirectional fibers). Non-limiting examples of some types of weaves that may be used for the fiber substrate 114 are a plain weave, a twill weave, a diagonal weave, and a harness satin weave. The support structure 114 may also be provided with a uniform distribution of fibers or may be constructed such that the fibers are strategically located and oriented so that it can be shown to strengthen the rotor body 100 in high stress areas, such as the root portions 104.

In one aspect, the core structure 116 can be formed entirely from a single material or a combination of materials. For example, the core structure 116 can be formed entirely from a polymeric thermosetting or thermoplastic or material. One example of a suitable polymeric material is a plastic resin, for example, foaming or non-foaming epoxy resins. Some examples of thermosetting materials usable for the core material 116 are vinylester, phenolic, and bismaleimide (BMI) materials. Some examples of thermoplastic materials usable for the polymeric material are polyamides (e.g. polyphthalamide), polyaryletherketones, and nylon. Other materials can be utilized that provide adequate thermal stability and adequate strength. In certain applications where operating temperatures are a concern, a core material 116 may be chosen that has a glass transition temperature that is at least as high or higher than the operating temperature. In one example, the core material 116 can be an epoxy resin having a glass transition temperature of 160° C. In one example, the core material 116 can be provided in the form of woven or non-woven materials, such as thermoplastic continuous fibers or chopped fibers, respectively.

Alternatively, the core structure 116 can additionally include pre-formed inserts that are placed into a mold along with the support structure 114. In such a configuration, the rotor body 100 can be finally formed by injecting a material, such as any of the aforementioned polymeric materials, foamed materials, and/or other low-density materials into the mold to secure the core structure 116 to the pre-formed inserts. The injected material can also flow into the mold to fill the void spaces thereby causing the overall shape of the rotor body 100 to be defined by the injected material. The pre-formed inserts may be of any type of suitable material, for example expanded polystyrene (EPS), expanded polyester (EPE), and expanded polypropylene (EPP) foams. The support structure 114 may be a pre-formed or cured component or may be configured to accept and/or absorb the polymeric material of the core structure 116 that becomes rigid once the polymeric material is cured within the mold.

It is further noted that the core structure 116 can be formed with hollow portions extending the length L of the rotor body 100. In one example, the central portions of the lobes 102 can be open such that hollow lobes 102 are formed. This can be accomplished by utilizing removable, pre-shaped inserts such as a foam core which can be removed after the core structure 116 is partially or fully cured. Alternatively, a mold defining the hollow portions could be utilized as well. Where it is desired to form a central opening 112, the central opening 112 can formed in the same manner.

Many different configurations for the support structure 114 are possible, as shown in FIGS. 1-3. FIG. 1 shows a configuration in which the support structure 114 is provided as a cylindrical inner sleeve 115 disposed about the central opening 112 and extending the length L of the rotor body 100. In one example, the cylindrical sleeve 115 is a pre-manufactured braided or woven carbon fiber sleeve. As shown, the cylindrical inner sleeve 115 is sized such that the sleeve is proximate the root portions 104 of the rotor body 100. The cylindrical sleeve 115 thus increases the strength of the rotor body 100 at this high stress area of the rotor body 100. As stated previously, the core structure 116 may include pre-formed inserts, injected polymeric material, or a combination of both. In one example, the volume of the rotor body 100 within the cylindrical inner sleeve 115 is provided as a pre-formed insert about which a braided carbon fiber sleeve is provided, wherein the volume outside of the cylindrical inner sleeve 115 is an injected polymeric material that also serves to wet the carbon fiber sleeve.

FIG. 2 shows an additional example of a support structure 114 for the rotor body 100, wherein the support structure 114 includes a cylindrical inner sleeve 115 and an exterior reinforcing sleeve 117. The cylindrical inner sleeve 115 is similar to that shown in FIG. 1 with the exception that the sleeve 115 of FIG. 2 extends all of the way to the root portions 104 of the rotor body. The exterior reinforcing sleeve 117 is provided in the shape of the outer perimeter 106 of the rotor body 100, which can be accomplished through a lay-up approach with raw fibers in the mold or by using a preformed sleeve, for example a sleeve pre-impregnated (pre-preg) with a polymeric material.

In one example, the exterior reinforcing sleeve 117 and the cylindrical inner sleeve 115 are adjacent to and in contact with each other at the root portions 104. In one example, the sleeves 115, 117 are secured together along all or a portion of the length L of the rotor body 100 at the root portions 104. One approach to securing the sleeves 115, 117 together is through the use of stitching 121, which may be accomplished with a material that is the same or different from the material used for sleeves 115, 117. By securing the sleeves 115, 117 together at the root portions 104, additional strength is provided to the rotor body 100 at this high stress area.

In one example, the volume of the rotor body 100 within the cylindrical inner sleeve 115 is provided as a pre-formed insert about which a braided carbon fiber sleeve is provided, wherein the exterior reinforcing sleeve 117 is also a braided carbon fiber sleeve. In such a configuration, the volume between the cylindrical inner sleeve 115 and the exterior reinforcing sleeve 117 can be an injected polymeric material, foamed material, and/or another low-density material that serves to wet the sleeves 115, 117. Alternatively, the majority of the volume between the sleeves 115, 117 can also be formed by pre-formed inserts with the remaining void spaces filled by an injected polymeric material, foamed materials, and/or other low-density materials.

The inner sleeve 115 can be formed from a different material than is used for the exterior sleeve 117. For example, the inner sleeve 115 could be formed from fiberglass and epoxy while the exterior sleeve 117 could be formed from carbon fiber and epoxy. The carbon fiber/epoxy exterior sleeve 117 provides the necessary stiffness to address issues with deflection that are a root cause for failures at high speeds. The glass/fiber epoxy inner sleeve 115 addresses differences in thermal expansion between the composite and the steel shaft 300. For example, if the rotor body 100 were all carbon fiber then the steel shaft 300 would expand faster causing high stresses in the root region of the rotor body 100 and subsequent failure. Tests have shown that using a glass/fiber inner sleeve 115 can ensure that the rotor body 100 can resist slippage on the shaft 300 at torques over 100 N-m (e.g. actual tests of an example rotor assembly 30 showed torque-to-slip of 103 N-m at room temperature and 115 N-m at 150 degrees Celsius). Torque-to-slip can be defined as being the retention force times the radius of the shaft divided by 1000, wherein the retention force is the radial force times the coefficient of friction of the rotor body 100, wherein the radial force is determined by analyzing the contact reaction of the interface between the shaft 300 and the rotor body 100.

In one particular embodiment, the inner sleeve 115 is formed from 40 percent by weight epoxy and 60 percent by weight chopped fiberglass while the exterior sleeve 117 is formed from 40 percent by weight epoxy and 60 percent by weight chopped carbon fiber. The sleeves 115, 117 can be pre-formed and placed into a mold, wherein the rotor core material is injected into the mold around the sleeves 115, 117. Alternatively, a pre-formed core material can be placed in the mold and the material for the sleeves 115 and/or 117 can be injected into the mold. In one example, the sleeve glass/epoxy inner sleeve 115 is in contact with the carbon/epoxy exterior sleeve 117. In a further refinement, the inner sleeve 115 can be provided to have a thickness of about 4 millimeters. Woven fiberglass and carbon fiber can also be used in the above described example, which could provide additional performance with regard to operating pressure ratios and temperatures. However, the use of chopped fibers can reduce manufacturing costs.

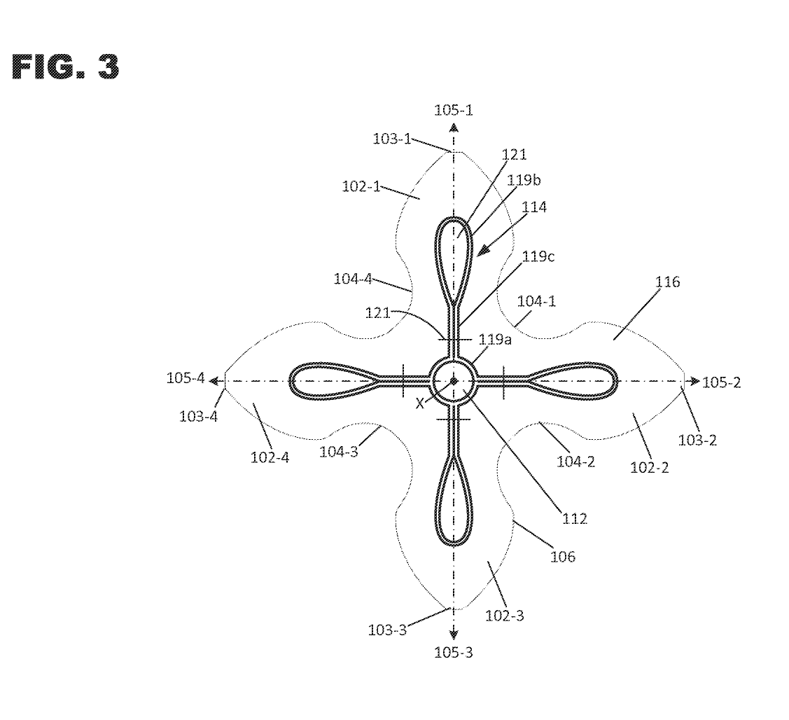

FIG. 3 shows yet another design for the support structure 114. As shown, an internal reinforcing structure 119 is provided having a core reinforcing portion 119a, end portions 119b and radial extensions 119c extending therebetween. As shown, the core reinforcing portion 119a is embedded within the core area of the rotor body 100 between the root portions 104 while the end portions 119b are embedded within the lobes 102 of the rotor body 100. Further layers of material can be added along the root areas 104 to provide additional reinforcement. In one example, the end portions 119b define an interior volume 119d into which the core structure material can flow within. In one example, extension portions 119c of the internal reinforcing structure 119 can be provided with stitching 121 to provide additional reinforcement. In one example, the internal reinforcing structure 119 can be pre-formed and loaded within a mold. Thereafter, resin can be injected into the mold to wet the fabric of the internal reinforcing structure 119 and form the body of the rotor body 100. In one example, the internal reinforcing structure 119 is initially provided as a cylindrical braided sleeve that is then shaped into having portions 119a, 119b, and 119c. The resulting structure allows the internal reinforcing structure 119 to be embedded within the rotor body 100 such that reinforcement is provided throughout the rotor body 100.

Referring to FIGS. 4-6, a second example of a composite rotor body 200 is shown. Many similarities exist between the first and second examples 100, 200 and the description for the first example 100 is thus applicable to the second example 200. Where similar features exist, similar reference numbers are utilized. However, the corresponding feature of the second example is designated with a 200 series reference number rather than the 100 series reference numbers utilized for the first example 100. The rotor body 200 is different from the rotor body 100 in that the rotor body 200 is shown as being provided with three lobes 202 rather than four lobes. Accordingly, the separation angle a1 between the lobes in the rotor body 200 can be 120 degrees instead of 90 degrees. As can also be seen at FIGS. 4-6, the shape and geometry of each individual lobe 202 and root portion 204 can be different from that shown in the first example.

Advantageously, the moment of inertia or rotational inertia of the composite rotor bodies 100, 200 (and thus the assembled rotor 30) can be substantially reduced as compared to a solid metal aluminum rotor. This reduced rotational inertia of the rotor bodies 100, 200 can have several benefits. For example, a rotor, gear, or other type of rotary component formed with a rotor body 100, 200 can be shown to accelerate more quickly and induce less wear on interconnected components, such as a clutch. Additionally, composite rotor bodies 100, 200 have a high hoop strength with sufficient strength in the root areas to prevent the lobes from disengaging from the central portions of the rotors. Since rotors may travel at speeds of 20,000 rpm in some applications, significant levels of hoop strength can be required, which are accomplished with the composite rotors of the present teachings.

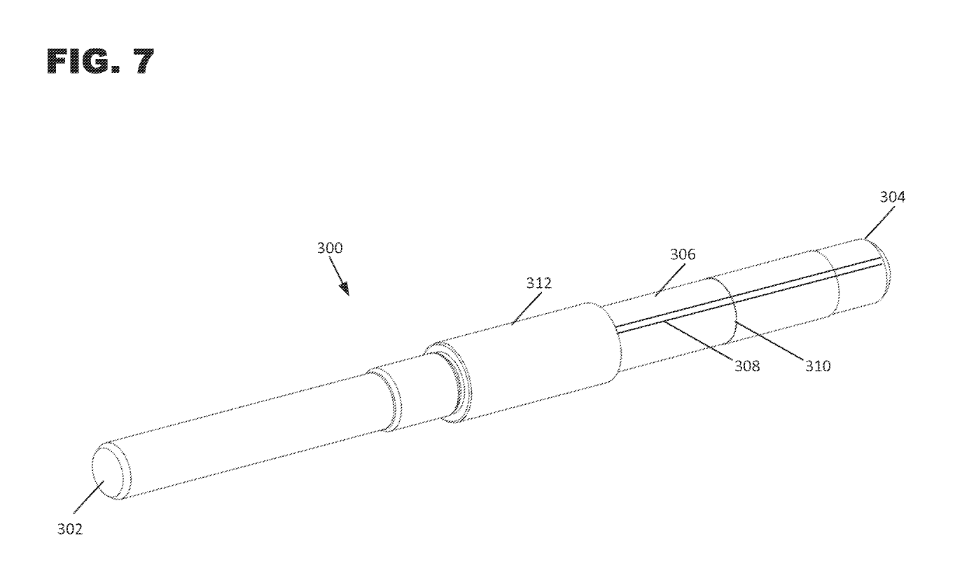

Referring to FIG. 7, a rotor shaft 300 is shown in accordance with the present teachings. Depending on application, the rotor shaft may be made from a composite material, aluminum, or steel (e.g. low carbon heat treated steel, stainless steel, etc.). The shaft 300 can extend through the central openings 112, 212 of the composite rotor body and, once secured to the shaft 300, enables power to be transmitted between the rotor body 100, 200 and an input or output device. As shown, rotor shaft 300 includes a first end 302 and a second end 304. The shaft 300 may be provided with a mounting section 306 which serves as a mounting location for the rotor body 100, 200 or a location onto which the rotor body may be molded.

The rotor shaft 300 may also be provided with one or more securing features that can function to secure the rotor body 100, 200 onto the rotor shaft 300. For example, knurling 308 may be provided on the surface of the mounting section 306 to increase the bond between the plastic resin 116, 216 of the rotor body 100, 200 and the rotor shaft 300. In some embodiments, the support structure 115, 119a, 215, 219a defines the central opening 112, 212 through which the shaft 300 extends. In one example, the support structure 115, 119a, 215, 219a is sized such that a press-fit connection between the support structure and shaft 300 is formed. In the examples shown, one or more surface features 308 are provided as a plurality of longitudinal recess in the surface of the mounting section 306 which lock the rotor body in the radial direction onto the rotor shaft 300. Examples of surface features 308 are knurling, burrs, and splines. Another securing feature that may be provided is a step portion 312 located at one end of the mounting section 306. As shown, the step section has a larger diameter than the mounting section 306 and thus prevents the rotor body 100, 200 from sliding longitudinally on the rotor shaft towards the first end 302.

The mounting section 306 may also be provided with one or more circumferential grooves 310 into which injected polymeric material 116, 216 can flow, thereby locking the rotor body 100, 200 in the axial direction onto the rotor shaft 300. It can be appreciated in light of the disclosure that the location of the circumferential groove 310 can be chosen to allow for thermal expansion between the rotor body 100, 200 and the shaft 300 to occur. One example of a suitable location is adjacent the step portion 312. The rotor shaft 300 may also be provided with splines which can extend along the full length of the mounting section 306.

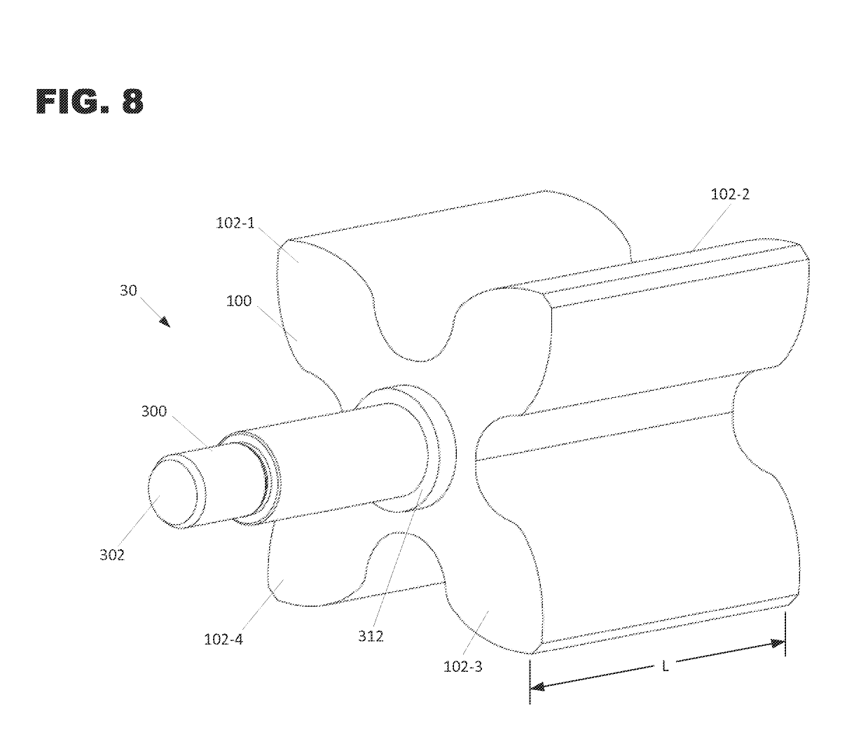

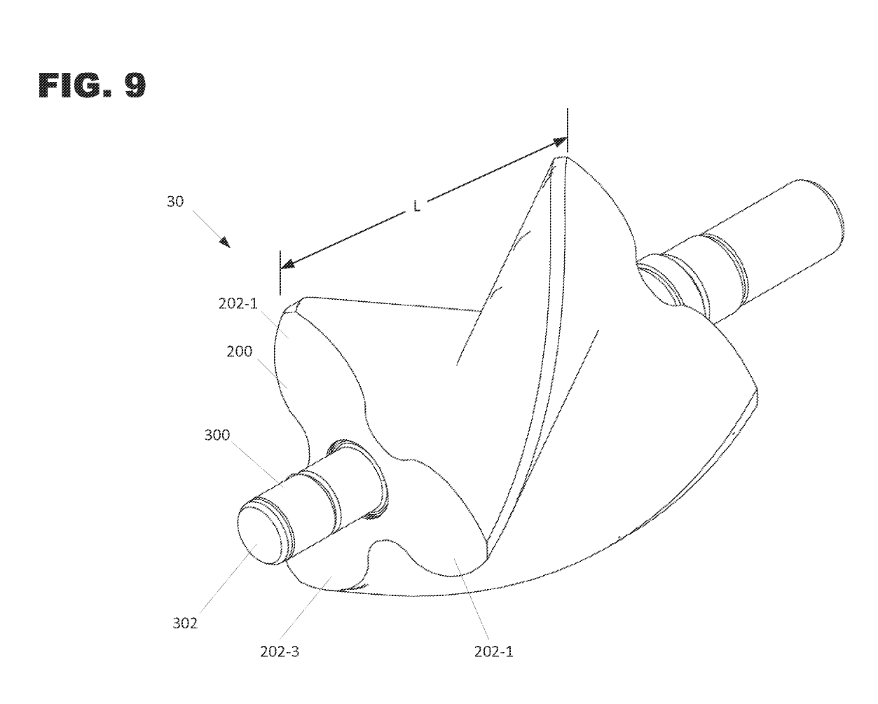

With reference to FIGS. 8 and 9, assembled rotors 30 using composite rotor body 100 and 200, respectively, are shown. Referring to FIG. 8, the rotor 30 is provided as a straight rotor. Referring to FIG. 9 the rotor 30 is provided as a helical rotor having either a constant helix angle or a varied helix angle (e.g. the degree of rotational offset increases and/or decreases along the length L of the rotor). It is noted that rotor body 100 can be provided as a helical rotor and that rotor body 200 can be provided as a straight rotor as well.

### Rotor Assembly Method 1000

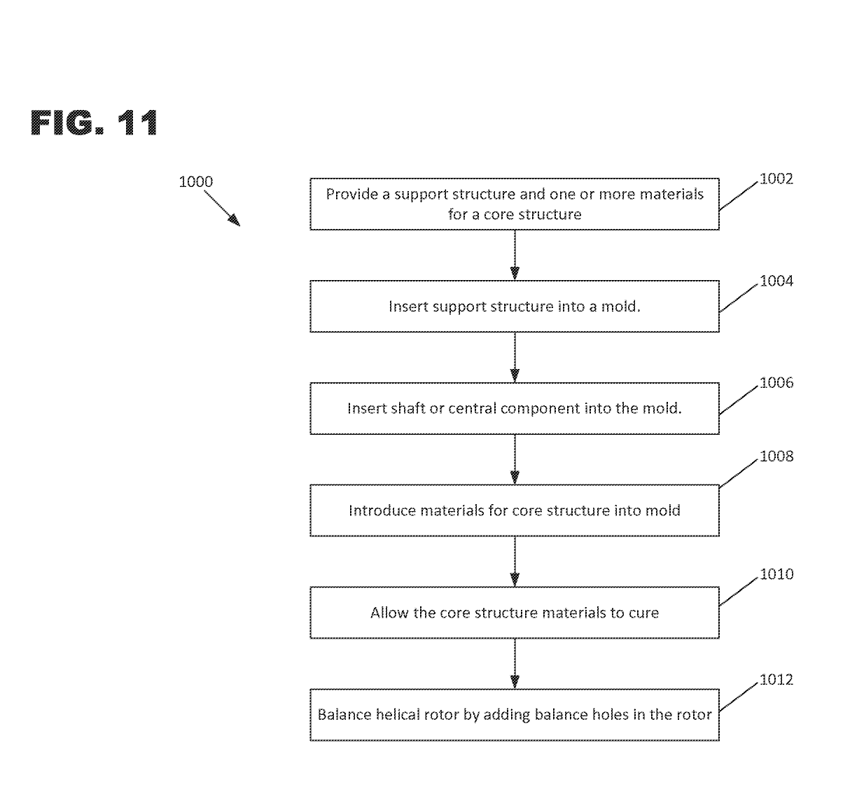

Referring to FIG. 11, an example of system and process 1000 in accordance with the disclosure is presented. It is noted that although the figures diagrammatically show steps in a particular order, the described procedures are not necessarily intended to be limited to being performed in the shown order. Rather at least some of the shown steps may be performed in an overlapping manner, in a different order and/or simultaneously. Also, the process shown in FIG. 11 is exemplary in nature and other steps or combinations of steps may be incorporated or altered without departing from the central concepts disclosed herein.

In a step 1002, a support structure and a material for a core structure in accordance with the present teachings are provided. In one example, the support structure can be pre-preg carbon fiber. In one example, the support structure is provided as only a fiber substrate. In one example, the core structure is initially provided as a pourable or injectable liquid polymeric material. In on example, the core structure is provided as a combination of pre-formed inserts and an initially liquid polymeric material.

In a step 1004, the support structure is placed into a mold. The mold may define a rotor body with straight or helical lobes, or may define a body for another type of rotary component, such as that for a gear.

In a step 1006, a shaft or other central component is inserted into the mold. Where a rotor with a molded-on shaft is not desired, a pre-shaped insert, such as a foam core can be inserted and later removed after the core structure is partially or fully cured. Alternatively, a hollow hub can be inserted through which a shaft can be inserted after the rotor is fully formed.

In a step 1008, the core structure materials are introduced into the mold. Where the core structure material is an initially liquid polymeric material, such as epoxy resin, step 1008 can include pouring or injecting the core structure material into the mold until the desired volume of the mold is filled with the core structure material. Where the core structure materials include inserts, the step 1008 can include first inserting the inserts and then injecting the polymeric material into the mold. Where necessary or desired, the support structure, shaft or central component, and/or inserts can be secured in place within the mold or secured by the mold prior to introducing the polymeric material into the mold.

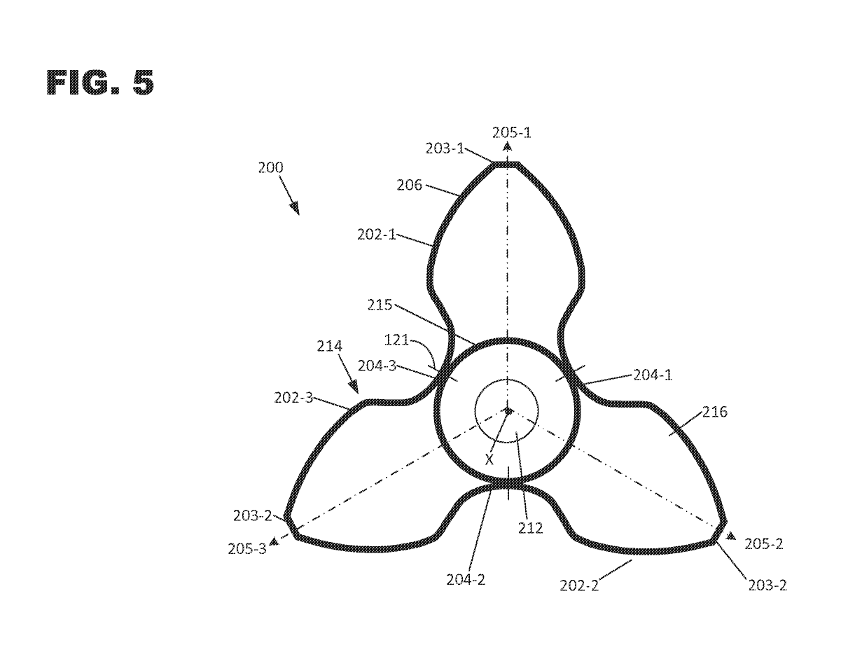

In a step 1010, the materials for the core structure are allowed to cure. This step can also include adding heat, especially in the case where thermoplastic materials are utilized. The assembly can be left within the mold until full curing has occurred or can be removed from the mold after a partial cure and moved to an oven that applies heat to the assembly for final curing. In some applications, a net-shape or near net-shape molding approach is used meaning that little or no finishing, to arrive at the final rotor shape, is required after curing of the core structure materials. In one example, where pre-preg carbon fiber is utilized for the examples of FIGS. 2 and 5, the outside surface of the fully cured rotor body 100, 200 can be substantially smooth, thereby eliminating the need to apply finishing techniques to the surface. Injection molding can also be utilized to provide the rotor body 100, 200 with a smooth outer surface formed by either the injected polymeric material of the core structure alone or a combination of the injected polymeric material and the exterior reinforcing sleeve. In some examples, it may be desirable to modify the outer surface in some manner. For example, it may be desirable to apply an abradable coating to allow tighter clearances between a pair of adjacent rotors 30.

In a step 1012, the rotor 30 can be balanced. In one example, balancing can be performed by removing material from one or more of the lobes of the rotor body 100, 200. One balancing approach is to use a drill to remove a pre-selected amount of material at a pre-determined location.

### Rotary Assembly Applications

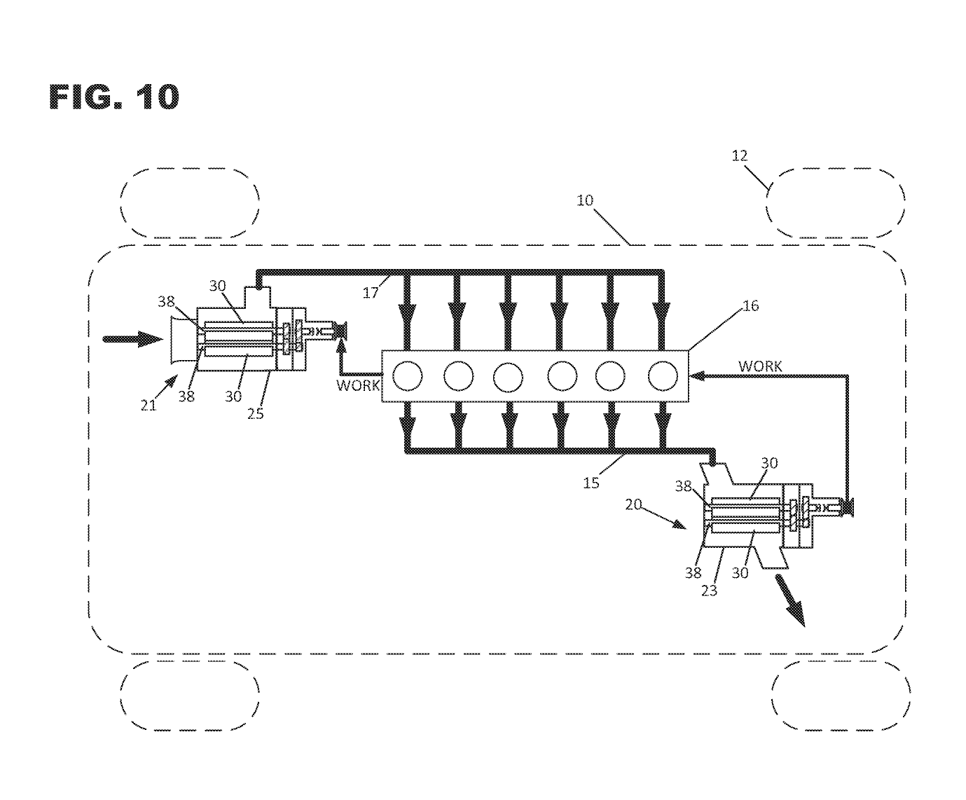

The above described rotor assembly 30 may be used in a variety of applications involving rotary devices. Two such applications can be for use in a fluid expander 20 and a compression device 21 (e.g. a supercharger), as shown in FIG. 10. In one example, the fluid expander 20 and compression device 21 are volumetric devices in which the fluid within the expander 20 and compression device 21 is transported across the rotors 30 without a change in volume. FIG. 10 shows the expander 20 and supercharger 21 being provided in a vehicle 10 having wheels 12 for movement along an appropriate road surface. The vehicle 10 includes a power plant 16 that receives intake air 17 and generates waste heat in the form of a high-temperature exhaust gas in exhaust 15. In one example, the power plant 16 is a fuel cell. The rotor assembly 30 may also be used as a straight or helical gear (i.e. a rotary component) in a gear train, as a rotor in other types of expansion and compression devices, as an impeller in pumps, and as a rotor in mixing devices.

As shown in FIG. 10, the expander 20 can receive heat from the power plant exhaust 15 and can convert the heat into useful work which can be delivered back to the power plant 16 (electrically and/or mechanically) to increase the overall operating efficiency of the power plant. As configured, the expander 20 can include housing 23 within which a pair of rotor assemblies 30 is disposed. The expander 20 having rotor assemblies 30 can be configured to receive heat from the power plant 16 directly or indirectly from the exhaust.

One example of a fluid expander 20 that directly receives exhaust gases from the power plant 16 is disclosed in Patent Cooperation Treaty (PCT) International Application Number PCT/US2013/078037 entitled EXHAUST GAS ENERGY RECOVERY SYSTEM. PCT/US2013/078037 is herein incorporated by reference in its entirety.

One example of a fluid expander 20 that indirectly receives heat from the power plant exhaust via an organic Rankine cycle is disclosed in Patent Cooperation Treaty (PCT) International Application Publication Number WO 2013/130774 entitled VOLUMETRIC ENERGY RECOVERY DEVICE AND SYSTEMS. WO 2013/130774 is incorporated herein by reference in its entirety.

Still referring to FIG. 10, the compression device 21 can be shown provided with housing 25 within which a pair of rotor assemblies 30 is disposed. As configured, the compression device can be driven by the power plant 16. As configured, the compression device 21 can increase the amount of intake air 17 delivered to the power plant 16. In one example, compression device 21 can be a Roots-type blower of the type shown and described in U.S. Pat. No. 7,488,164 entitled OPTIMIZED HELIX ANGLE ROTORS FOR ROOTS-STYLE SUPERCHARGER. U.S. Pat. No. 7,488,164 is hereby incorporated by reference in its entirety.

### Material Selection

Where the rotors 30 are disposed in a housing, such as housings 23 and 25, it will be appreciated in light of the disclosure that proper consideration must be given to material selection for the rotors and the housing in order to maintain desirable clearances between the rotors and housing. For example, improper material selection can result in a rotor that expands when heated by a working fluid (e.g. engine exhaust, ethanol, water, air, etc.) into the interior wall of the housing, thereby damaging the rotor and housing. It will be appreciated in light of the disclosure that proper selection of materials having appropriate relative coefficients of thermal expansion can result in a rotor that, in the expanded state, will not contact an also expanded housing and will maintain a minimum clearance between the rotors and housing for maximum efficiency across a broader range of temperatures. Also, as the rotors are more directly exposed to the working fluid (e.g. exhaust gases or a solvent used in a Rankine cycle) and the housing can radiate heat to the exterior, the rotors can be shown to expand to a greater degree than the housing. By way of the present example, the material for the rotors that can have a coefficient of thermal expansion that is lower than a coefficient of thermal expansion of the housing.

As the composite rotors 100, 200 can be provided with materials having relatively low coefficients of thermal expansion, more materials may be available for the housings 23, 25, such as magnesium and aluminum. In one example, carbon fiber rotors are used in conjunction with an aluminum or housing. As carbon fiber has a lower coefficient of thermal expansion than aluminum, both the housing and the rotors will expand, but to a degree wherein each component expands to achieve clearances that allow for maximum efficiency. Furthermore, as the fiber orientation has an effect on the growth of the rotor, the fiber orientation can be selected to further minimize clearances to increase performance and efficiency. Of course, many other possibilities exist for rotor and housing materials based on desired performance criteria.

It will also be appreciated in light of the disclosure that the plastic resin 116, 206 selected for the rotors 30 could also be used for applications having low or high temperatures. For example, a standard epoxy resin may limit the operation of the rotors 30 in fluid handling applications where fluid is between about −40° C. and about 150° C.

While the best modes for carrying out the many aspects of the present teachings have been described in detail, those familiar with the art to which these teachings relate will recognize various alternative aspects for practicing the present teachings that are within the scope of the appended claims.

What is claimed is:

1. A composite rotor assembly comprising:
a. a shaft; and
b. a rotor body mounted to the shaft, the rotor body including:
i. a core structure including a cured polymeric material, the core structure defining a first length, a central opening through which the shaft extends and a plurality of lobes extending away from the central opening, each of the lobes being joined by an adjacent root portion and having a longitudinal axis intersecting the center of the central opening;
ii. a support structure continuously extending the length of the core structure and being at least partially embedded within the core structure, the support structure including a plurality of fibers.

2. The composite rotor assembly of claim 1, wherein the plurality of fibers of the support structure are carbon fibers and wherein the cured polymeric material of the core structure is an epoxy resin.

3. The composite rotor assembly of claim 2, wherein the carbon fibers of the support structure are pre-impregnated with a polymeric material.

4. The composite rotor assembly of claim 2, wherein the support structure is provided as a braided carbon fiber sleeve.

5. The composite rotor assembly of claim 1, wherein the core structure additionally includes at least one insert structure, the at least insert structure being formed from a foam material.

6. The composite rotor assembly of claim 1, wherein the support structure is formed as a cylindrical inner sleeve.

7. The composite rotor assembly of claim 6, wherein the cylindrical inner sleeve is disposed between the central opening and the root portions between the lobes.

8. The composite rotor assembly of claim 7, wherein the support structure further includes an outer reinforcement sleeve disposed about an outer perimeter of the core structure, the outer perimeter being defined by the plurality of lobes and root portions.

9. The composite rotor assembly of claim 8, wherein the outer reinforcement sleeve and the cylindrical inner sleeve are secured together proximate the root portions of the core structure.

10. The composite rotor of claim 9, wherein the outer reinforcement sleeve and the cylindrical sleeve are secured together by stitching.

11. The composite rotor of claim 1, wherein the support structure is entirely embedded within the core structure.

12. The composite rotor of claim 11, wherein the support structure is formed with a core reinforcing portion and a plurality of radial extensions extending away from the core reinforcing portion, wherein the core reinforcing portion is located between the central opening and the root portions of the core structure, wherein each radial extension extends into one of the plurality of lobes of the core structure.

13. The composite rotor of claim 12, wherein the support structure is provided as a single braided sleeve that is formed into the core reinforcing portion and the radial extensions.

14. The composite rotor of claim 13, wherein the support structure is provided with stitching to define the shape of the radial extensions.

15. The composite rotor of claim 11, wherein the support structure further includes a plurality of ends portions, wherein each of the plurality of end portions is connected to one of the radial extensions.

16. The composite rotor of claim 15, wherein each of the plurality of end portions defines an interior volume within which the cured polymeric material of the core structure is present.

17. A method of making a composite rotor, the method comprising the steps of:
a. providing a support structure and one or more materials for a core structure;
b. inserting the support structure into a mold;
c. inserting a shaft into the mold;
d. introducing the one or more materials for the core structure into the mold;
e. allowing curable portions of the one or more materials of the core structure to cure; and
f. removing the composite rotor from the mold.

18. The method of making a composite rotor of claim 17, wherein the step of providing one or more materials for a core structure includes providing an epoxy resin, and the step of introducing the one or more materials for the core structure into the mold includes injecting the epoxy resin into the mold.

19. The method of making a composite rotor of claim 18, wherein the step of providing a support structure includes inserting a support structure formed from a carbon fiber sleeve.

20. The method of making a composite rotor of claim 17, wherein the epoxy resin wets and bonds with the carbon fiber sleeve.

21. A composite rotor assembly comprising:
a. a shaft; and
b. a rotor body mounted to the shaft, the rotor body including:
i. a core structure including a cured polymeric material, the core structure defining a first length, a central opening through which the shaft extends and a plurality of lobes extending away from the central opening, each of the lobes being joined by an adjacent root portion and having a longitudinal axis intersecting the center of the central opening;
ii. a support structure continuously extending the length of the core structure and being at least partially embedded within the core structure, the support structure including:
1. an inner sleeve disposed between the central opening and the root portions between the lobes; and
2. an outer sleeve disposed about an outer perimeter of the core structure, the outer perimeter being defined by the plurality of lobes and root portions.

22. The composite rotor assembly of claim 21, wherein the inner sleeve includes a first plurality of fibers and the outer sleeve includes a second plurality of fibers.

23. The composite rotor assembly of claim 22, wherein the first plurality of fibers is formed from a material that is different from a material from which the second plurality of fibers are formed.

24. The composite rotor assembly of claim 23, wherein the first plurality of fibers is fiberglass and the second plurality of fibers is carbon fiber.

25. The composite rotor assembly of claim 24, wherein the first and second plurality of fibers include chopped fibers.

26. The composite rotor assembly of claim 21, wherein the inner sleeve is formed from chopped fiberglass and epoxy and wherein the outer sleeve is formed from chopped carbon fiber and epoxy.

27. The composite rotor assembly of claim 26, wherein the inner sleeve is approximately 60 percent by weight chopped fiberglass and approximately 40 percent by weight epoxy and wherein the outer sleeve is approximately 60 percent by weight chopped fiberglass and approximately 40 percent by weight epoxy.

28. The composite rotor assembly of claim 21, wherein the inner sleeve is in contact with the outer sleeve.

29. The composite rotor assembly of claim 28, wherein the inner sleeve is bonded to the outer sleeve.
